(19) United States
(12) Patent Application Publication
(10) Pub. No.: US 2009/0154362 A1
(43) Pub. Date: Jun. 18, 2009

(54) METHOD AND APPARATUS FOR MONITORING OF A NETWORK DEVICE

(76) Inventors: CHIN-WANG CHAO, Lincroft, NJ (US); Wenwen Ji, Cedar Knolls, NJ (US); Byron D. Johnson, Durham, NC (US); Herman Lee, Morganville, NJ (US); John Lee, Bartlett, IL (US); Ker-Ren Tu, Manalapan, NJ (US); Chris Vestal, Durham, NC (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 11/958,861

(22) Filed: Dec. 18, 2007

(51) Int. Cl. G06F 11/00

(52) U.S. Cl. 370/241

(57) ABSTRACT

A method and apparatus for monitoring of a network device are disclosed. For example, the method receives a monitoring record from a network device, and determines whether the network device is listed in an active pool of monitored network devices. The method then automatically enables the monitoring of the network device if the network device is not listed in the active pool of monitored network devices.

The present invention relates generally to communication networks and, more particularly, to a method and apparatus for automatic enabling and disabling of monitoring of a network device used for communication over a communication network, e.g., a packet network, an Internet Protocol (IP) network, a Voice over Internet Protocol (VoIP) network, and the like.

### BACKGROUND OF THE INVENTION

When a customer signs up for a communication service from a service provider, certain network assets or devices may be assigned to the customer and monitored by a service monitoring application. The service monitoring application utilizes various computing resources for monitoring of the network assets/devices. For example, the monitoring application may monitor one or more devices or assets that are being used by one or more customers. When a customer terminates the service, the devices or assets may be de-commissioned and the dedicated computing resources in the monitoring application may be manually de-provisioned to enable the service provider to reuse the computing resources. However, manual provisioning and de-provisioning processes are subject to human errors. When errors occur during provisioning of computing resources in the monitoring application, certain devices may be left without proper monitoring until one or more customers call in to report service troubles or equipment failure. Such service impairments may cause business interruption to the customers and may also force the service provider to incur financial penalty. For example, a penalty clause may be included in service agreements with one or more customers. In another example, computing resources in the monitoring application may not be de-provisioned properly at the end of a service termination, and may cause performance slow down and/or false alarms as these computing resources may be tied to nonexistent services and/or devices.

### SUMMARY OF THE INVENTION

In one embodiment, the present invention discloses a method and apparatus for monitoring of a network device. For example, the method receives a monitoring record from a network device, and determines whether the network device is listed in an active pool of monitored network devices. The method then automatically enables the monitoring of the network device if the network device is not listed in the active pool of monitored network devices.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network for providing automatic enabling and disabling of monitoring of a network device;

FIG. 3 illustrates a flowchart of the method for automatic enabling and disabling of monitoring of a network device; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for automatic enabling and disabling of monitoring of a network device used in communication networks, e.g., packet networks, IP network, Voice over Internet Protocol (VoIP) networks, and the like. Although the present invention is discussed below in the context of IP networks, the present invention is not so limited. Namely, the present invention can be applied for other telecommunication networks, e.g., cellular networks and the like.

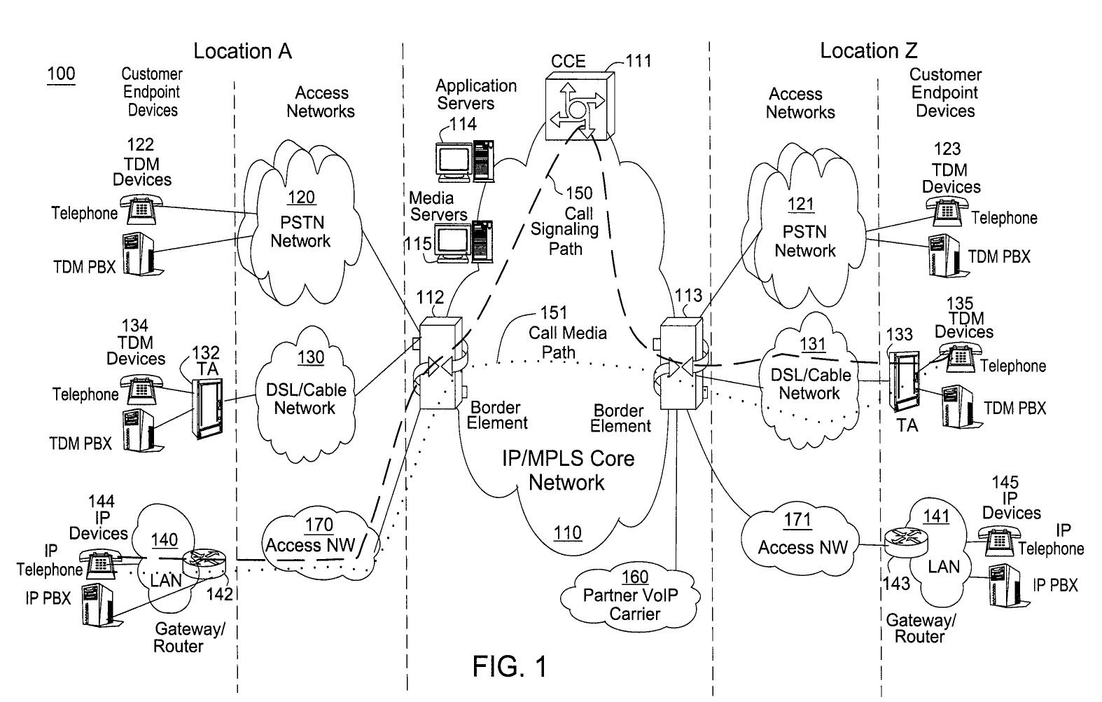

To better understand the present invention, FIG. 1 illustrates a communication architecture 100 having an example network, e.g., a packet network such as a global IP/MPLS core network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the IP/MPLS core network may comprise various types of customer endpoint devices connected via various types of access networks to a carrier (a service provider) core infrastructure over an Internet Protocol/Multi-Protocol Label Switching (IP/MPLS) based core backbone network. Broadly defined, a VoIP or SoIP network is a network that is capable of carrying packetized data for voice or other data services over the IP network. The present invention is described below in the context of an illustrative VoIP network. Thus, the present invention should not be interpreted as limited by this particular illustrative architecture.

The customer endpoint devices can be either Time Division Multiplexing (TDM) based or IP based. TDM based customer endpoint devices 122, 123, 134 and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 with a VoIP gateway or router 142 and 143, respectively.

The access network can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. The customer gateway/router is connected to an access network, 170. A packet based access network 130 or 131, such as DSL or Cable, when used together with a TA 132 or 133, is used to support TDM based customer endpoint devices.

The IP/MPLS core VoIP infrastructure comprises of several key VoIP components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on.

For calls that originate or terminate in a different carrier, they can be handled through the PSTN 120 and 121, or the Partner VoIP Carrier 160. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network 170, 171, to BE 112. BE 112 will then send a setup-signaling message, such as a SIP-INVITE message if SIP is used, to CCE 111. CCE 111 looks at the called party information and queries the necessary VoIP service related application server 114 to obtain the information to complete this call. In one embodiment, the Application Server (AS) functions as a back-to-back user agent. If BE 113 needs to be involved in completing the call, CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the called party accepts the call at location Z, a call acknowledgement signaling message, such as a SIP 200 OK response message if SIP is used, is sent in the reverse direction back to the CCE 111. After the CCE 111 receives the call acknowledgement message, it will then send a call acknowledgement-signaling message, such as a SIP 200 OK response message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different because once a call has been setup between two endpoints, the CCE 111 does not need to be in the data path for actual direct data exchange.

Media Servers (MS) 115 are special servers that typically handle and terminate media streams, and to provide services such as announcements, bridges, transcoding, and Interactive Voice Response (IVR) messages for VoIP service applications. The media servers also interact with customers for media session management to accomplish tasks such as process requests.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

At end of a call, a Call Detail Record (CDR) is generated by the gateway routers, 142, 143 and sent to the service monitoring application, 114 to provide operational and accounting details of the call. The application monitoring application, 114, will analyze the CDR for possible network or service problems and also store the CDR for reporting and billing purposes.

The above network is described to provide an illustrative environment in which customers may transmit and receive packets for various communications services such as VoIP, SoIP, etc. When a customer signs up for a communication service from a service provider, certain network assets or devices may be assigned to the customer and monitored by a service monitoring application, 114. The service monitoring application may utilize various computing resources to monitor the network assets/devices.

During the life cycle of the communications service, such computing resources may be fine tuned to provide the best solution for identifying service or device failures based on service performance and real-time device alarms. When a customer terminates the service, the devices or assets may be de-commissioned and the dedicated computing resources in the monitoring application may be de-provisioned to enable the service provider to reuse the computing resources in the monitoring application. Provisioning and de-provisioning of the computing resources can be performed manually, but are subject to human errors. When errors occur during provisioning of computing resources in the monitoring application, certain devices may be without proper monitoring until one or more customers call in to report service troubles or equipment problems. Such service impairment causes business interruption to the customers and may also force the service provider to incur financial penalty. In another example, computing resources in the monitoring application may not be de-provisioned properly at the end of a service termination, and may cause performance slow down and/or false alarms as these resources may be tied to nonexistent services and/or devices.

In one embodiment, the present invention discloses a method and apparatus for automatic enabling or disabling of monitoring network devices used in telecommunication networks. For example, the method enables a network service provider to receive a monitoring record (e.g., a Call Detail Record (CDR), a heartbeat signal, and the like) from a device at a customer location. The device at the customer location may comprise a router, a switch, a firewall, a wireless access point device, and the like.

If the monitoring record is a CDR, the CDR may include details of a call such as the calling party, the called party, the source and destination addresses of the routers or switches handling the call, the time of the call, the duration of the call, the quality of service, the disposition of the call including whether or not the called party was busy, the phone was ringing with no answer and the like. In one example, a gateway router, 142, 143, at a customer premise may be configured to send CDRs to a service monitoring application to report status of the calls.

Alternatively, the monitoring record can be implemented as a heartbeat signal. If the monitoring record is a heartbeat signal, then the heartbeat signal may include various parameters such as the source IP address or hostname of the device, time of day, etc.

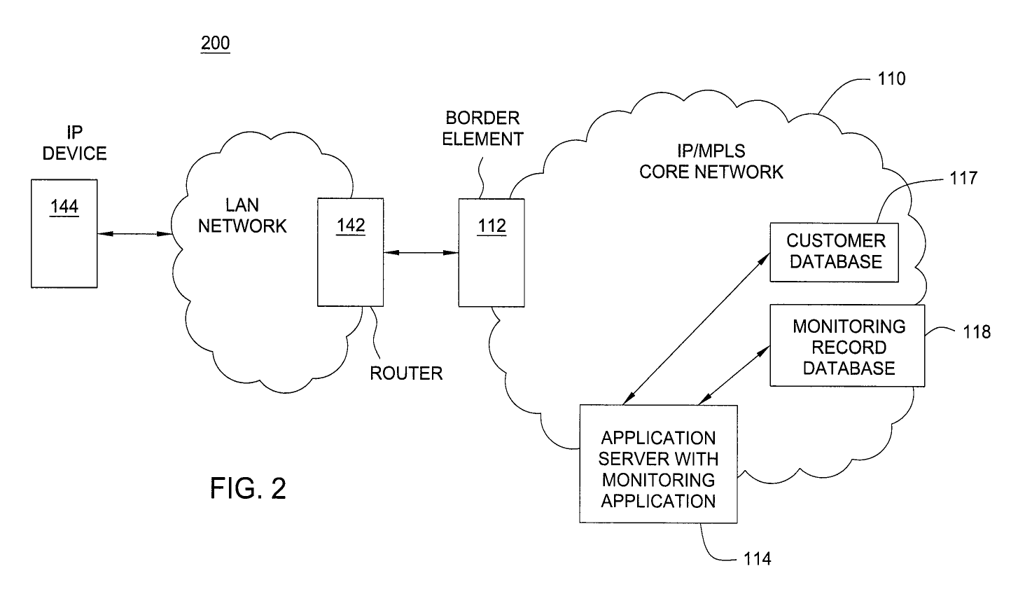

FIG. 2 illustrates an exemplary network 200 for providing automatic enabling or disabling of monitoring a network device. For example, the IP device 144 is deployed for accessing communications services such as VoIP through a LAN 140. The packets transmitted by IP device 144 traverse the LAN 140 towards the gateway/router 142. The router is connected to the IP/MPLS core network 110 through the border element 112. Packets originated by the IP device 144 traverse the core network 110 from border element 112 towards their destination. The IP/MPLS core network 110 also contains an application server 114, a customer database 117, and a monitoring record database 118. In one embodiment, the network service provider implements the current invention for automatic monitoring of devices in the application server 114. For example, the current invention for automatic monitoring of devices can be referred to as a “monitoring application”.

In one embodiment, the customer database 117 contains customer information, such as the customer names, types of service subscribed by each customer, one or more customer devices used for accessing subscribed services, the source addresses of the customer devices, the customer device identifications, monitored/non-monitored, and so on. Broadly, the customer database 117 contains pertinent information relating to the customers of the service provider.

In one embodiment, the monitoring record database 118 may contain monitoring records such as CDRs and/or heartbeat signals that have been received from one or more customer devices. Additionally, information pertaining to these monitoring records such as the IP addresses of the customer devices that sent the monitoring records, the time stamps as to when these monitoring records were received, and so on, can also be stored in the monitoring record database 118.

In one embodiment, the present invention provides a method to automatically enable and disable monitoring a network device. For example, a customer may subscribe to a managed service from a service provider that provides pro-active monitoring of the customer devices, e.g., fault detection of the service and the devices. The customer may then configure the customer device to send monitoring records to the application server 114, which is connected to the customer database 117 and the monitoring record database 118. This allows the application server 114 to access and/or to update the stored customer information in the customer database 117, and to store the received monitoring records into the monitoring record database 118.

It should be noted that although the present invention is disclosed in the context of monitoring a customer device, the present invention is not so limited. Namely, a subscribed service for a customer may involve the use of a customer device in conjunction with one or more network devices of the network service provider. In one embodiment, the monitored network devices may only comprise customer network devices, whereas in another embodiment, the monitored network devices may comprise customer network devices and service-provider network devices that are needed to provide the subscribed service.

The service provider may utilize the monitoring application in the server 114 to process the data included in the received monitoring records. For example, if the received monitoring record is the first monitoring record received from a customer device, the monitoring application may retrieve from the monitoring record, an IP address, a hostname, one or more call monitoring parameters, thresholds, quality of service requirements, etc. and enables the monitoring of the customer device automatically.

In one embodiment, the information needed for enabling the monitoring of a customer device is included in the monitoring record. In another embodiment, some information such as IP address is retrieved directly from the monitoring record, whereas other information such as the quality of service requirements for the customer or whether the customer has subscribed to the device monitoring service may be retrieved from another database, e.g., customer database 117. In another example, a customer may determine whether the pro-active monitoring method should be enabled and/or disabled for a given device. For example, the customer may define a range of IP addresses of customer devices to be monitored, or the customer may define a geographical location of customer devices to be monitored, or the customer may define the time of day that the customer devices are to be monitored, and so on. These monitoring parameters can be stored and accessed in customer database 117. Thus, different customers may have different parameters for enabling and disabling the monitoring method of the present invention.

In another example, the service provider may define a set of monitoring thresholds for service performance and quality monitoring. One or more performance metrics can be calculated from one or more monitoring records sent by the customer or network devices. When a performance or quality metric exceeds or falls below the pre-defined threshold, an alarm will be generated by the monitoring application to notify the work center staffs of the possible service impairment or degradation.

Once enabled, the monitoring application may begin monitoring of the customer device in accordance with the retrieved information from the monitoring record and/or from a customer database. For example, the monitoring application may begin identifying and recording failure alarms associated with a customer device.

In one embodiment, the present monitoring application is able to automatically assess whether monitoring of a customer device should be continued. As discussed above, allocating network resources to continually monitor customer devices is costly to a service provider. As such, it is important to a service provider that such network resources are not needlessly wasted in monitoring dormant customer devices. For example, a customer device may be become dormant if the customer ceases to use a particular customer device to access the subscribed service, or the customer may simply have terminated the subscribed service. Thus, it is important that the present monitoring application is able to automatically determine these events and then properly disables the monitoring of these dormant customer devices.

In one embodiment, the monitoring application may keep track the timestamp of a last received monitoring record from each of the customer devices that it monitors to identify dormant customer devices. For example, the service provider may configure the monitoring application to use a Last Record Elapse Time (LRET) and a Cleanup Cycle Time (CCT) to facilitate the disabling of the monitoring of dormant customer devices. The Last Record Elapse Time refers to a maximum time interval that is allowed to elapse after the last monitoring record is received from a customer device, before monitoring of the customer device is automatically disabled. For example, if the LRET is set to be 48 hours, then the monitoring of a customer device can be terminated automatically when 48 hours have elapsed after the last monitoring record is received. It should be noted that the time period set for LRET can be selectively set by the service provider and/or the customer.

Cleanup Cycle Time (CCT) refers to a time interval for the monitoring application to scan a monitoring device table of an active pool of monitored customer devices. The monitoring device table represents a list of customer devices that are currently being monitored. The table is updated with the timestamp of the last monitoring record received from the customer device. The scanning of the table allows customer devices that have been inactive for an extended period of time to be removed from the table. All the computing resources associated with the inactive device will be returned to the reuse pool. For example, CCT can be selectively set to be 1 hour, 2 hours, 1 week, 1 month, etc. For the example above, if the CCT is set to one week, then the monitoring application may perform cleanup on a weekly basis to disable monitoring of customer devices that have exceeded their LRET. For example, a customer device may be removed from the monitoring pool if 48 hours have elapsed since the last monitoring record is received for the customer device. The method may then de-provision the computing resources in the monitoring application that were allocated to the monitoring of the customer device, such that these computing resources may be reused. For example, memories used for storing monitoring records in a database may be reused for another customer device. However, if a customer device at a customer location sends a monitoring record at a later time after monitoring of that customer device has been disabled, then the current method may automatically enable the monitoring of that customer device.

Those skilled in the art will realize that the customer database, the monitoring record database, and the monitoring application can be implemented in the same device or in separate devices. The above embodiment only illustrates one exemplary method of implementing the present invention and it is not intended to limit the present invention to this particular implementation. Furthermore, FIG. 2 only illustrates the network elements that are used to describe the present invention. It is not intended to show all network elements used to deliver a VoIP or similar service.

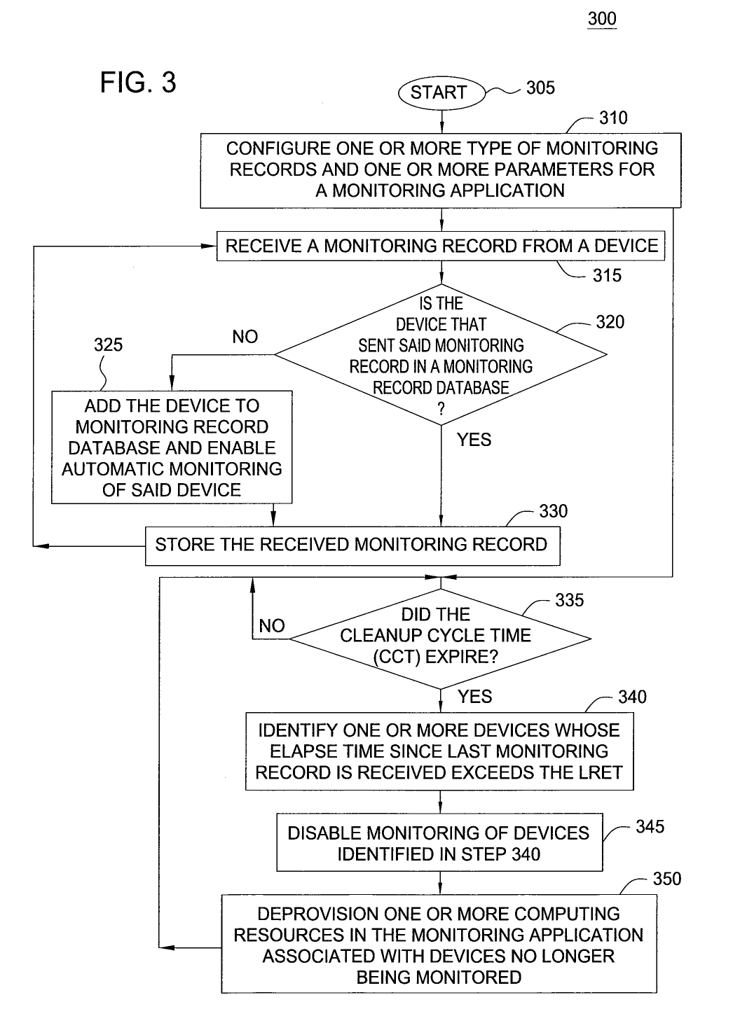

FIG. 3 illustrates a flowchart of a method 300 for providing automatic enabling or disabling of monitoring a customer device. Method 300 starts in step 305 and proceeds to step 310.

In step 310, method 300 configures one or more parameters for a monitoring application. For example, the type of monitoring record is configured, e.g., selecting a CDR or a heartbeat signal as the monitoring record. The type of information carried by the monitoring record can also be selectively configured. The method may also configure one or more parameters such as the Last Record Elapse Time (LRET), Cleanup Cycle Time (CCT), one or more parameters to be retrieved from the monitoring records or a customer database, e.g., IP addresses, thresholds, quality of service, and so on. The method then proceeds to step 315 or to step 335.

In step 315, method 300 receives a monitoring record from a customer device. For example, a customer device sends a call detail record to a monitoring application.

In step 320, method 300 determines whether or not the customer device that sent the monitoring record is currently in an active customer device monitoring pool. For example, the monitoring application may determine whether or not it recognizes the customer device by comparing its IP address with IP addresses in an active monitoring device table. If the customer device is in the table, then the method proceeds to step 330. Otherwise, the method proceeds to step 325.

In step 325, method 300 adds the customer device to the active monitoring device table and enables automatic monitoring of the customer device. For example, the method may retrieve IP address, hostname, one or more call monitoring parameters, thresholds, quality of service requirements, etc. of the device from the received monitoring record and/or a customer database, and then enables the monitoring of the customer device. It should be noted that in one embodiment, the customer device will only be added if it is also determined that the customer has subscribed to the device monitoring service. Otherwise, the customer device will not be added to the active monitoring device table. The method then proceeds to step 330.

In step 330, the method stores pertinent information of the received monitoring record. For example, the method may store the received monitoring record into monitoring record database 118. The method then returns to step 315.

In step 335, method 300 determines whether or not the cleanup cycle time has expired. For example, the monitoring application may have a cleanup cycle time of one week. The method may then determine whether or not one week has elapsed since the previous cleanup. If the cleanup cycle time has expired, the method proceeds to step 340. Otherwise, the method loops back to step 335.

In step 340, method 300 identifies one or more customer devices whose elapsed time since last monitoring record is received exceeds the LRET. For example, if the LRET is configured in step 310 to be 48 hours, the method may identify one or more customer devices that have not sent a monitoring record in the last 48 hours. For example, the method may identify dormant customer devices that may be candidates for being removed from the monitoring pool.

In step 345, method 300 automatically disables monitoring of the customer devices whose elapsed time since last monitoring record is received exceeds the LRET. For example, the method disables monitoring of one or more customer devices identified in step 340. The method then proceeds to step 350.

In step 350, method 300 de-provisions one or more computing resources in the monitoring application that are associated with one or more customer devices that are no longer being monitored. For example, the method de-provisions computing resources associated with one or more customer devices identified in step 340. For example, memories used for storing monitoring records in a database may be reused for other customer devices. The method then proceeds to step 335 to continue checking if CCT expires.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

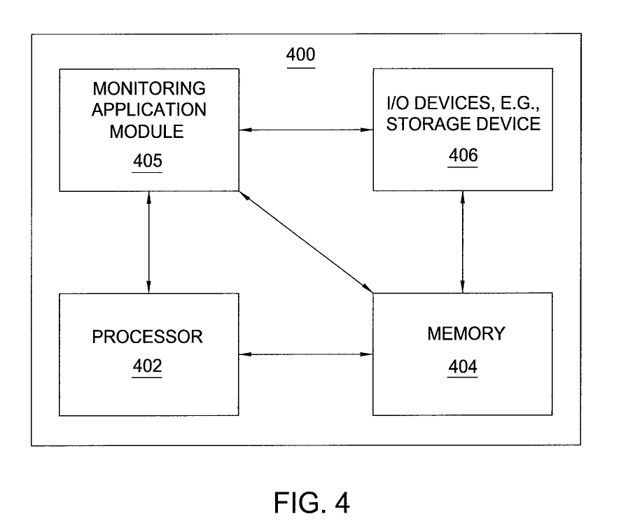

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing automatic monitoring of a network device, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, alarm interfaces, power relays and the like)).

It should be noted that the present invention can be implemented in software and/or in a combination of software and hardware, e.g., using application specific integrated circuits (ASIC), a general-purpose computer or any other hardware equivalents. In one embodiment, the present module for providing automatic monitoring of a network device or process 405 can be loaded into memory 404 and executed by processor 402 to implement the functions as discussed above. As such, the present method 405 for providing automatic monitoring of a network device (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for monitoring a device in a communication network, comprising:
receiving a monitoring record from a network device;
determining whether said network device is listed in an active pool of monitored network devices; and
enabling monitoring of said network device if said network device is not listed in said active pool of monitored network devices.

2. The method of claim 1, further comprising:
adding said network device to said active pool of monitored network devices; and
storing said monitoring record in a database.

3. The method of claim 1, wherein said communication network is a packet network.

4. The method of claim 1, further comprising:
updating said active pool of monitored network devices in accordance with a first predefined period of time.

5. The method of claim 4, wherein said updating comprises identifying one or more network devices listed on said active pool of monitored network devices, where an elapsed time measured from a last monitoring record associated with said one or more network devices is received, has exceeded a second predefined period of time.

6. The method of claim 5, further comprising:
removing said identified one or more network devices from said active pool of monitored network devices.

7. The method of claim 6, further comprising:
disabling monitoring of said removed one or more network devices.

8. The method of claim 7, further comprising:
de-provisioning one or more computing resources allocated for monitoring said removed one or more network devices.

9. The method of claim 1, wherein said monitoring record comprises at least one of: a call detail record or a heartbeat signal.

10. The method of claim 1, wherein said network device comprises a customer network device.

11. A computer-readable medium having stored thereon a plurality of instructions, the plurality of instructions including instructions which, when executed by a processor, cause the processor to perform the steps of a method for monitoring a device in a communication network, comprising:
receiving a monitoring record from a network device;
determining whether said network device is listed in an active pool of monitored network devices; and
enabling monitoring of said network device if said network device is not listed in said active pool of monitored network devices.

12. The computer-readable medium of claim 11, further comprising:
adding said network device to said active pool of monitored network devices; and
storing said monitoring record in a database.

13. The computer-readable medium of claim 11, further comprising:
updating said active pool of monitored network devices in accordance with a first predefined period of time.

14. The computer-readable medium of claim 13, wherein said updating comprises identifying one or more network devices listed on said active pool of monitored network devices, where an elapsed time measured from a last monitoring record associated with said one or more network devices is received, has exceeded a second predefined period of time.

15. The computer-readable medium of claim 14, further comprising:
removing said identified one or more network devices from said active pool of monitored network devices.

16. The computer-readable medium of claim 15, further comprising:
disabling monitoring of said removed one or more network devices.

17. The computer-readable medium of claim 16, further comprising:
de-provisioning one or more computing resources allocated for monitoring said removed one or more network devices.

18. The computer-readable medium of claim 11, wherein said monitoring record comprises at least one of: a call detail record or a heartbeat signal.

19. The computer-readable medium of claim 11, wherein said network device comprises a customer network device.

20. An apparatus for monitoring a device in a communication network, comprising:
means for receiving a monitoring record from a network device;
means for determining whether said network device is listed in an active pool of monitored network devices; and
means for enabling monitoring of said network device if said network device is not listed in said active pool of monitored network devices.
